(19) United States
(12) Patent Application Publication
(10) Pub. No.: US 2010/0230960 A1
(43) Pub. Date: Sep. 16, 2010

(54) GENDERLESS FLANGE FOR HIGH VACUUM WAVEGUIDES

(75) Inventor: Richard S. Konecny, Downers Grove, IL (US)

Correspondence Address: MICHAEL J. CHERSKOV, 300 NORTH STATE STREET, SUITE 5102, CHICAGO, IL, 60654, US

(73) Assignee: UCHICAGO ARGONNE, LLC, Chicago, IL (US)

(21) Appl. No.: 12/488,101

(22) Filed: Jun. 19, 2009

Related U.S. Application Data
(60) Provisional application No. 61/133,455, filed on Jul. 1, 2008.

(51) Int. Cl. F16L 19/02

(52) U.S. Cl. 285/336

(57) ABSTRACT

A system of genderless flanges suitable for high vacuum waveguides is provided, comprising a metallic gasket between a pair of identical flanges where the configuration of the gasket conforms to within 100 microns to the cross-section of the inner surface of the waveguides. The invention also provides a method for manufacturing a mechanical junction for identical electromagnetic radiation waveguides, the method comprising: supplying a pair of identical flanges, each of said flanges defining an axially extending an inwardly facing axial surface defining a first aperture opening adapted to receive a waveguide, each of the flanges having an outwardly facing axial surface defining a second aperture opening with a perimeter equal to within 100 microns to the inner perimeter of the waveguides; inserting a first end of a first wave guide into the first aperture opening of a first of said flanges and inserting a first end of a second wave guide into the first aperture opening of a second of said flanges and permanently bonding the wave guides to their respective flanges; positioning each of said flanges such that the outwardly facing axial surfaces of the flanges oppose each other; positioning a gasket between the opposing surfaces, wherein the inner perimeter of the gasket is within 100 microns of the inner perimeter of the wave guide; and applying axial pressure to the outwardly facing axial surfaces of the flanges to provide a hermetic seal between the flanges.

### PRIORITY INFORMATION

This application claims the benefit of U.S. Provisional Application No. 61/133,455 filed on Jul. 1, 2008.

### FIELD OF THE INVENTION

The present invention relates to the field of high vacuum flanges and more specifically, the present invention relates to the field of high vacuum flanges that are specifically designed for the interconnection of high frequency waveguides.

### BACKGROUND OF THE INVENTION

Transmission of high frequency (wavelengths in the range of about 10 cm to 0.001 cm) electromagnetic radiation is often accomplished by means of waveguides, which are conduits manufactured from high electric conductivity metals. Increasingly, high frequency electromagnetic radiation waveguides have to operate in vacuum.

Quite frequently, several waveguides must be joined to each other. As much as possible, these junctions thus must, first, be leak-proof from a vacuum point of view, and second, present no impedance to the high frequency electromagnetic radiation traversing in the waveguides. Most commonly, these junctions are effected by welding or brazing a flange at each end of a waveguide and then bolting or otherwise attaching together a “first” flange at a “first” end of a first waveguide to a “second” flange at a corresponding end of the “second” waveguide. It has proven most convenient to design “genderless” flanges, i.e. flanges such that there is no difference between the “first” and “second” flange so that any two flanges can be chosen at random to be joined together. Thus waveguides and other components can have flanges bonded to them ahead of time prior to actual design of the required assembly.

State of the art arrangements provide for high vacuum flanges where there is considerable electromagnetic impedance at a junction. Low electromagnetic impedance flanges exist but they are not suitable for high vacuum applications.

Thus, there is a need in the art for genderless flanges suitable for high vacuum waveguides. The flanges should provide junctions presenting very little impedance to electromagnetic waves transmitted by the waveguides. These flanges should also provide junctions with high mechanical reliability.

### SUMMARY OF THE INVENTION

An object of the present invention is to provide genderless flanges suitable for high vacuum waveguides that overcome the disadvantages in the prior art.

Another object of the present invention is to provide a system of genderless flanges suitable for high vacuum waveguides that provide junctions that facilitate transmission of electromagnetic radiation. A feature of the present invention is a metallic gasket adapted to be positioned intermediate between a pair of flanges where the configuration of the inner perimeter of the gasket conforms to within 100 microns to the cross-section of the inner surface of the waveguide. An advantage of the present invention is that it provides seamless junctions that present minimal impedance (i.e. less than 0.05 dB per joint) to electromagnetic waves transmitted by the waveguides.

Still another object of the present invention is to provide a system of genderless flanges suitable for high vacuum waveguides that provide junctions with high mechanical reliability. A feature of an embodiment of the present invention is two concentric seals, effected by either one or two gaskets, at a junction formed by a pair of flanges. An advantage of the present invention is that a large torque can be applied at a junction between two waveguides without breaking the vacuum seal.

In brief, this invention generally discloses a system of genderless flanges suitable for high vacuum waveguides that provide junctions that facilitate transmission of electromagnetic radiation by the waveguides by means of a metallic gasket between a pair of flanges where the configuration of the inner perimeter of the gasket conforms to within 100 microns to the cross-section of the inner surface of the waveguide. An embodiment of the present invention features a single gasket forming two concentric seals at a junction between a pair of flanges. Another embodiment of the present invention features two concentric gaskets forming two concentric seals at a junction between a pair of flanges.

A method for joining electromagnetic radiation waveguides is provided, the method comprising supplying a pair of identical flanges, each flange defining a first surface adapted to receive a first end of a waveguide, and a second surface for frictionally engaging an electrically conductive gasket; positioning said gasket between opposing second surfaces, such that the gasket contacts at least one circumferentially extending, axially projecting ridge formed on each second surfaces; inserting a first end of a first waveguide into said first surface of one of said flanges and inserting a first end of a second waveguide into said first surface of second of said flanges; and applying axial pressure to said first surfaces so as to deform the gasket by the ridges.

The invention also provides a method for manufacturing a mechanical junction for identical electromagnetic radiation waveguides, the method comprising: supplying a pair of identical flanges, each of said flanges defining an axially extending an inwardly facing axial surface defining a first aperture opening adapted to receive a waveguide, each of the flanges having an outwardly facing axial surface defining a second aperture opening with a perimeter equal to within 100 microns to the inner perimeter of the waveguides; inserting a first end of a first wave guide into the first aperture opening of a first of said flanges and inserting a first end of a second wave guide into the first aperture opening of a second of said flanges and permanently bonding the wave guides to their respective flanges; positioning each of said flanges such that the outwardly facing axial surfaces of the flanges oppose each other; positioning a gasket between the opposing surfaces, wherein the inner perimeter of the gasket is within 100 microns of the inner perimeter of the wave guide; and applying axial pressure to the outwardly facing axial surfaces of the flanges to provide a hermetic seal between the flanges.

### BRIEF DESCRIPTION OF THE DRAWING

The invention together with the above and other objects and advantages will best be understood from the following detailed description of the preferred embodiment of the invention shown in the accompanying drawing, wherein:

FIG. 1 is a cross sectional view of a genderless flange in accordance with features of the present invention;

FIG. 2a is a sectional profile view of the genderless flange in FIG. 1 taken along the line 2-2, in accordance with features of the present invention;

FIG. 3a is a sectional profile view of two genderless flanges having a gasket positioned between the flanges, in preassembled form, in accordance with features of the present invention;

FIG. 3b is a sectional profile view of two genderless flanges having a gasket positioned between the flanges, in assembled form, in accordance with features of the present invention; and

FIG. 4 is a plan view of a gasket, in accordance with features of the present invention.

### DETAILED DESCRIPTION OF THE INVENTION

The present invention provides a system of genderless flanges suitable for high vacuum waveguides, accommodating pressures as low as 3×10⁻¹⁰ Torr. In operation the flanges form junctions that facilitate seamless transmission of electromagnetic radiation by the waveguides through centrally located apertures that match the cross-sections of the inner surfaces of the waveguides. The system includes a metallic gasket between a pair of flanges where the configuration of the inner perimeter of the gasket conforms to the cross-section of the central aperture of the flange. This gasket forms two seals: an inner seal matching the inner surface of the waveguide and an outlying seal radially displaced from the inner seal. An alternative embodiment of the present invention features two gaskets: an inner gasket matching the inner surface of the waveguide and an outlying gasket positioned at a second pair of opposing surfaces of the flange, these opposing surfaces being radially displaced from the aforementioned inner surface.

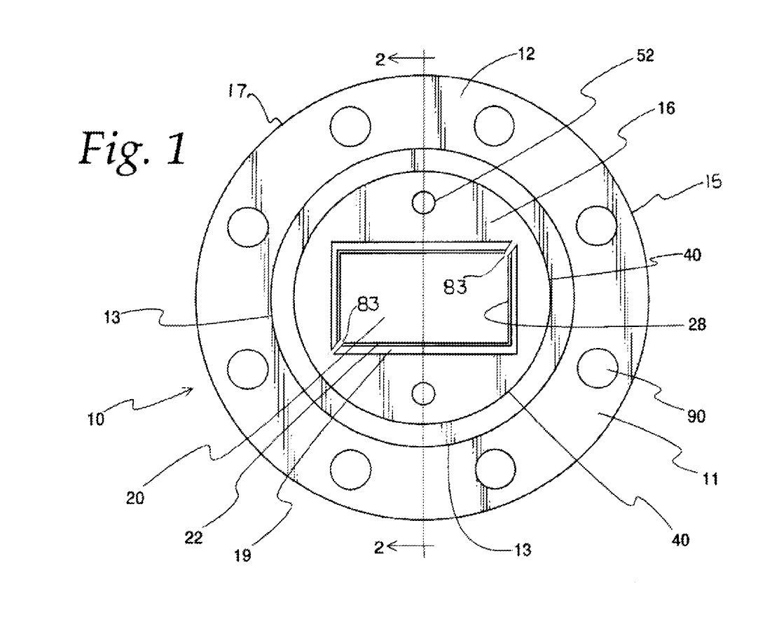

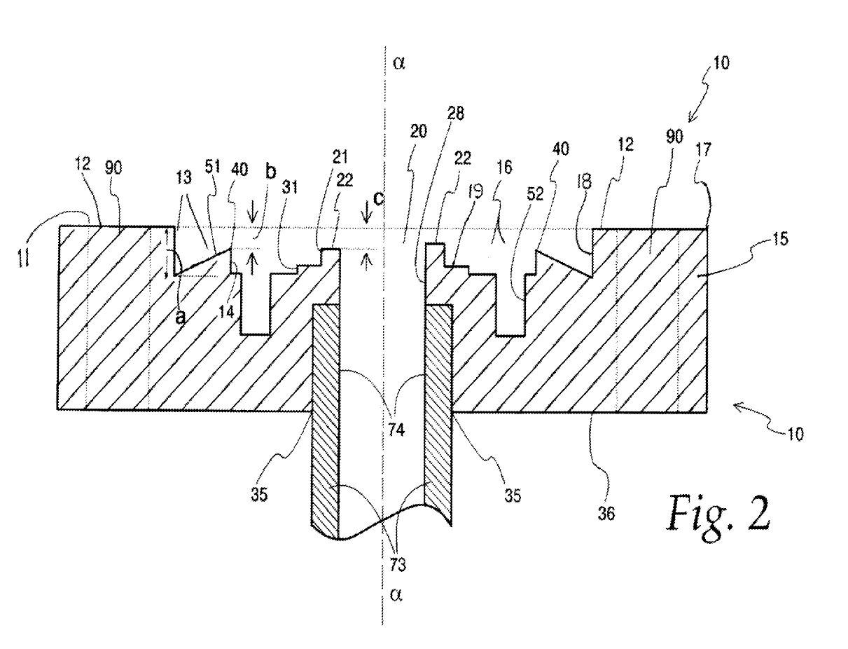

FIG. 1 is a plan view of a genderless flange 10 and FIG. 2 is a sectional profile view of the flange in FIG. 1 taken along the line 2-2. An exemplary embodiment of the invented flange 10 comprises a plate 15 with an interior, axially facing surface 11 having a central region defining an interior aperture 20. The interior aperture extends axially so as to be coaxial with the longitudinal axis of any waveguides mated to the flange.

An exterior, axially-facing surface 36 of the flange comprises a central region defining an exterior aperture 35. The periphery (i.e., the inner diameter or medially-facing surface) 28 of the interior aperture 20 is continuous and contiguous with the inner diameter (i.e., inwardly or medially-facing) surface 74 of a waveguide 73 when the waveguide is slidably received by the exterior aperture 36 and welded or braised to the flange. (See FIG. 2) The exterior surface 36 of the flange 10 defines an aperture 35 adapted to slidably receive the waveguide 73 to which the flange is subsequently welded or brazed. The inner diameter or medially-facing surface of the exterior aperture 35 is generally continuous with the outer diameter of the waveguide.

Plating of the inner or medially facing surfaces improves loss factor (aka S21) through the flange. S21 represents the parameters which measure input versus output strength of the radiation. Such plating metals include, but are not limited to copper, gold, and silver. Plating thicknesses can vary. Typical thicknesses range from about 5 microns to 15 microns.

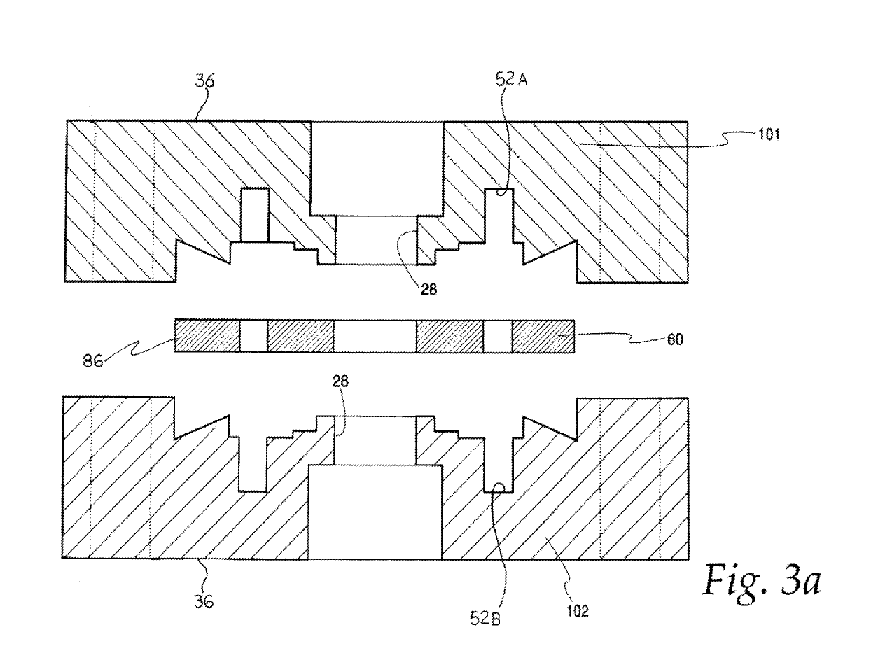

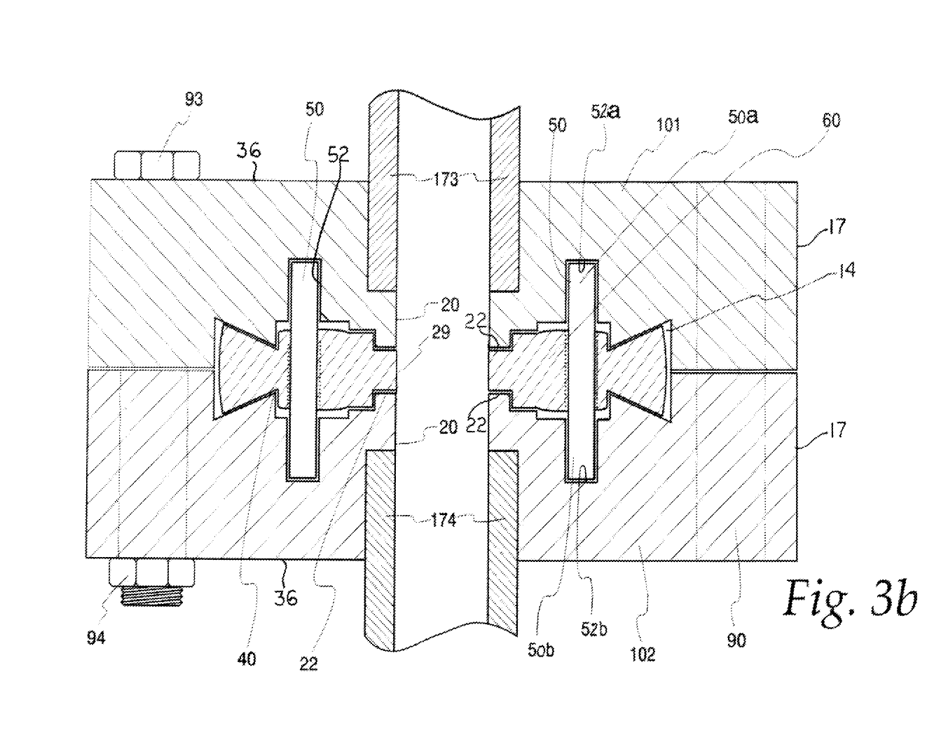

FIG. 2 depicts the main elements of the interior surface 11 of the flange, i.e. the surface that will oppose an identical surface of a second identical flange. This embodiment renders the connection genderless, when a junction is formed. The interior surface comprises a plateau 22 with an inner periphery 28 bordering the aperture 20, a depression 16 circumscribing the plateau 22, and a laterally displaced, axially protruding ridge 40 circumscribing the depression 16. Under certain circumstances, the ridge 40 may be dispensed with. A mid region of depression 16 defines axially extending apertures 52. The apertures 52 are optionally threaded and extend in a direction generally perpendicular to the surface 11. The axially extending apertures 52 are adapted to removably receive guide pins 50, which are depicted in FIG. 3b. A plurality of circular bores 90 circumscribe the ridge 40 and are positioned radially from the ridge 40 so that the ridge 40 is positioned intermediate the interior aperture 20 and the bores 90.

Typically, waveguides have rectangular cross sections. When such waveguides are joined together, adjacent waveguide walls should remain aligned with each other. Flanges used in a specific installation are usually manufactured as a batch so as to ensure alignment. The invented flange can be used in conjunction with rectangular, circular and arbitrarily shaped waveguides.

### Flange Face Detail

As shown in FIG. 2, the face 11 of the flange 10 is symmetric about the axis α and comprises a first plateau 12 extending inwards (i.e. medially directed) from the flange perimeter 17. The plateau comprises the bores 90. The inner perimeter of said plateau is defined by a groove 13 of depth a. In one embodiment of the invention, the groove is defined by two surfaces placed at an acute angle to each other. A first surface includes a portion of the ridge 40, that portion originating at the bottom of the groove and medially slanting upward to define a sloped surface 51. The sloped surface 51 originates from the bottom of the groove 13 and terminates at a height b below the plane formed by the plateau 12, with b<a. A second surface 18 defining the groove 13 originates at the bottom of the groove and extends axially to the face of the interior surface 11. Extending axially from the terminus is a relatively flat, medially facing surface 14 which terminates at the same plane as that formed by the depression 16. A region of the surface of the depression 16 extends medially to define a third plateau 19 that lies at depth c below the i.e., first plateau 12, with b<c<a. The plateau i.e. is terminated by a step 31 comprising an axially extending, laterally facing flat surface i.e. facing toward the outer periphery 17 of the plate 15, away from the longitudinal axis α of the flange). The third plateau 19 extends inwardly to a step 21 defining a fourth plateau 22, at a depth b below the first plateau 12. The fourth plateau 22 has a periphery 28 that circumscribes the aperture 20.

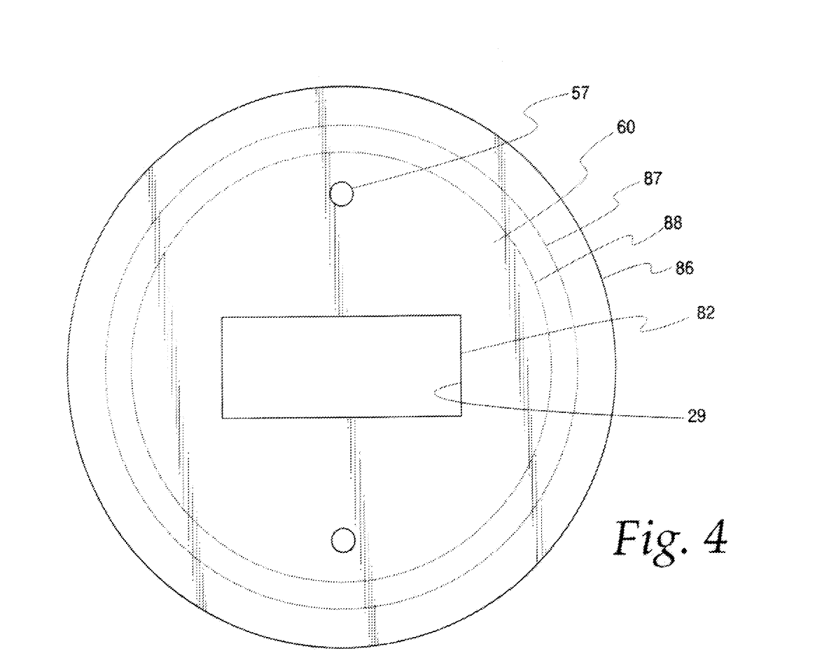

FIG. 3a is a sectional profile view of two opposing genderless flanges 101 and 102 having a gasket 60 positioned between the flanges, in preassembled form. FIG. 3b is a sectional profile view of a first flange 101 and a second flange 102 in assembled form with the gasket 60 positioned between the flanges. The waveguides 173, 174 are also shown in place so as to be extending in a direction generally parallel to the longitudinal axis α of the assembled flanges. (A plan view of the gasket 60 is shown in FIG. 4.) The flanges 101 and 102 are used to effect a junction between the waveguides 173 and 174 such that the interior, axially facing surface 11 of each flange opposes each other. As more clearly depicted in FIG. 4, the gasket 60 defines an aperture 82 having an inner diameter 29 substantially the same (i.e. within 100 microns) as the diameter defined by an inner surface 28 of the interior apertures 20. The outer periphery 86 of the gasket 60 is situated medially from the groove 13 of each of the two flanges.

When the flanges are joined together, the grooves 13 of each flange oppose each other to form a frusto-circularly shaped cavity 14. The cavity 14 is therefore adapted to receive the shape of the bulging periphery 86 of the gasket 60 as inward axial pressure is applied to the axially facing exterior (i.e., oppositely facing) surfaces 36 of each of the flanges 10. The flanges are bolted to each other by means of bolts 93 slid through the bores 90 and tightened onto nuts 94. Other fastening means are suitable.

Two seals are formed: a first inner seal on the plateau 22 and a second, outer seal on the ridge 40, the second seal positioned radially from the first seal such that the second seal is intermediate the periphery 17 of the flange and the first seal. As stated sura, the outer seal may be dispensed with under certain circumstances. Preferably, the material comprising the gasket 60 is an oxygen-free, high conductivity material. Exemplary material is a metal selected from the group consisting of copper, tin, silver, aluminum, indium, and alloys thereof, with indium being especially suitable for cryogenic applications. The flange junction described above has a leak rate of less than 3×10⁻¹⁰ Torr liters/sec Helium. To evacuate the volume between the plateau 22 and the ridge 40, fluid evacuation ports or channels, such as radially-extending grooves in the gasket 60, are provided.

To facilitate alignment of the gasket and flanges assembly, guide pins 50 may be provided. One embodiment comprises the pins constituting shanks slidably received in matching cavities. This is shown in FIG. 3b where a first end 50a of the pin is matingly received by a cavity 52a (having similar cross section as the first end of the pin) in flange 101 before the two flanges are brought together. As the flanges are brought together, a second end 50b of the pin 50 is slidably received by a cavity 52b having a complementary cross section, and formed in the second flange 102. It can be appreciated that the flanges 101 and 102 are interchangeable so that the pin could be first inserted into flange 102.

In an alternative embodiment, a pin 50 comprises a shank portion and a threaded section with the thread extending from the shank. The threaded section of the pin is adapted to be received by a female threaded cavity 52 in the flange 101 prior to the flange junction being assembled. When the flanges are brought together, the shank portion of the pin is slidably received in a cavity having a compatible cross section to that of the shank in the second flange 102. Again, given the interchangeability of the flanges, the pin could be screwed into the flange 102 instead. The gasket 60 comprises transverse apertures 57 which slidably receive the guide pins 50.
When the guide pin 50 is slid into the receiving cavities 52, trapped fluids, such as gases may exist along the sides and bottom of the cavities. In an embodiment of the invention, a longitudinally extending side of the cavity 52 defines a machined, or otherwise positioned groove or channel. (Alternatively, a longitudinally extending side of the guide pin 50 defines a groove or channel.) This provides a means of egress for the aforementioned trapped fluids. Instead of, or in addition to the aforesaid grooves, the longitudinal axis of the guide pin 50 defines an aperture extending completely through the longitudinal axis of the pin, so as to facilitate drainage of any trapped fluid.

### Two Gasket

### Detail

An embodiment of the invention comprises two gaskets. Under certain circumstances, an inner seal may be formed employing a soft-metal inner gasket positioned on the fourth plateau 22 while a second seal is formed by employing a soft-metal or an elastomer outer gasket positioned on the ridge 40. Preferably, the outer periphery of the inner gasket circumscribes the guide-pin cavities 52. The outer gasket is positioned along the flange at a point radially displaced from the inner seal. The outer periphery of the outer gasket is situated medially of the groove 13 so that the gasket is sandwiched by, and contacts opposing ridges 40 of the two flanges. The inner periphery of the outer gasket (i.e., the periphery of the outer gasket 85 which defines its inner diameter) is positioned medially from the outer ridge 40. (The inner periphery 87 of the outer gasket 85 and the outer periphery 88 of the inner gasket are depicted by dotted lines in FIG. 4.) Each of the ridges 40 define a continuous axially protruding rim such that the rim circumscribes a midregion of the flange. The rim is coaxial with the central axis a of the flange.

When the bolts are tightened, the gaskets form ultra-high vacuum joints which are “bakeable.” For example, to achieve ultra high vacuum conditions, metal structure temperatures are raised to about 200 to 400 C. This drives moisture and other gasses from the vacuum walls of the chamber. As such, gasket material is chosen to withstand temperatures from about 200 to 400 C. Bakeable gasket material is therefore chosen from the group comprising copper, tin, silver, aluminum, indium and alloys thereof. If “bakeability” is not required, any soft material is suitable for the outer gasket while the inner gasket preferably is fabricated from oxygen-free high conductivity material.

Between the continuous rim defined by the ridge 40 and the plateau 22 of the flange resides the depression 16 in the flange's topography. When the two opposing surfaces of the flanges are joined, the depression of each flange forms a cavity. This formed cavity provides a means for monitoring any fluid leaking between the gaskets. In an embodiment of the invention, a monitoring orifice is provided, such that a region of the exterior axially facing surface 36 of the flange defines an axially extending bore. The bore provides fluid communication between the formed cavity and the exterior of the flange-waveguide construct. An exterior mouth of this bore is adapted to receive a first end of a conduit such as a flexible tubing. A second end of the tubing communicates with a pump and or analyzing device. This configuration facilitates monitoring of the atmosphere between the seals, for example by analyzing outgassing occurring at either or both seals to determine leakage. This configuration also allows for pressure to be applied to the chamber to verify seal tightness at positive, elevated pressures.

One may dispense with the outer gasket 85 in situations where there is little torque tending to separate two facing flanges. In an embodiment of the invention, a groove 83, or a plurality of grooves, radially extending from the inner diameter aperture 29 of the flange is provided to allow evacuation of the volume from between the inner and the outer gaskets. FIG. 4. Shows two grooves positioned at diametrically opposed corners of the inner diameter, as a preferred configuration, so as to minimize waveguide electrical disturbance. However, placement of the groves around any point of the periphery of the inner diameter aperture 29 is suitable.

Generally, the groove 83 or grooves 83 are machined on the plateau 22 of the inner sealing surface of the flange so as to provide a fluid egress conduit from the depression 16 area of the flange to its interior aperture 20. The actual depth and width of the groove should be sufficient to provide a conduit of egress of any fluid residing between the inner and outer gaskets. For example, a groove about 0.01″ wide and about 0.005″ deep is suitable. While one groove is sufficient, an even number, (i.e. two) can be utilized to confer balance and even seating of the gasket against the flange surfaces.

The invention enables a seamless junction between two electromagnetic radiation waveguides. A pair of identical flanges is provided, each of said flanges defining an axially extending aperture adapted to receive a waveguide. Each of the flanges have an exterior or outwardly facing surface defining a first axially-extending aperture and an interior inwardly facing surface defining a second axially extending aperture (wherein the apertures are coaxial to each other. A first end of a first waveguide is inserted into the first aperture opening of a first of said flanges and a first end of a second waveguide is inserted into the first aperture opening of a second of said flanges. The waveguides are bonded to their respective flanges. The two flanges are positioned such that the interior or inwardly facing axial surfaces of the flanges oppose each other. A gasket or a plurality of gaskets, is placed between the opposing surfaces, (wherein the tolerances of the inner perimeter of the gasket are within 100 microns of the inner diameter of the waveguide); axial pressure is applied to the outwardly facing axial surfaces of the flanges, thereby providing a hermetic seal between the flanges.

The present invention provides genderless flanges for the junction of two identical waveguides. The flanges are bonded to their respective waveguides by welding, soldering, or brazing. A gasket and guide pins are placed between the flange faces of two adjoining waveguides and the flanges are brought together and bolts are slid into bores on the periphery of the flanges. Nuts are tightened on the bolts in a cris-cross tightening pattern by means of a torque-measuring wrench.

A myriad of wavelengths are accommodated by the invented flange, ranging from 200 megaHz (MHz) to 100 gigaHz (GHz). The physical size of the wave guide varies inversely to the frequency. For example, in one embodiment, a wave guide for accommodating 200 MHz is approximately 24 inches in diameter, whereas a wave guide for accommodating a 90 GHz frequency is 60/1000ths of an inch in diameter.

While the invention has been described in the foregoing with reference to details of the illustrated embodiment, these details are not intended to limit the scope of the invention as defined in the appended claims. The invented configuration provides a leak-type seal between the opposing ends of two conduits.

The invented configuration provides a means for joining opposing ends of conduits through which can flow any fluid, whether that fluid be a gas or a liquid. Material choices of the flange and the conduits are determined by the fluid being transported. For example, while the appended claims recite a method and means for accommodating electromagnetic radiation, the leakless transport of alkaline, acidic, high temperature and low temperature fluids are facilitated by selecting relatively inert construction materials for wetted surfaces, which include the internal surfaces of the flange and conduits. If acid is transported through the construct, an elastomer material, or some other acid-tolerant substrate is utilized as a gasket material, instead of the metal gaskets used for electromagnetic radiation transport. Likewise, an alkaline-tolerant material would be used for the gasket in instances where an alkaline fluid is being transported.

Pressures accommodated by the joining means depend on the strength of the conduits utilized. Internal pressures of from 20,000 to 30,000 psi are accommodated by the flange. Negative pressures are also accommodated by the flange. Temperature ranges are also determined based on the materials utilized.

1. A method for joining electromagnetic radiation waveguides, the method comprising:
a) supplying a pair of identical flanges, each flange defining a first surface adapted to receive a first end of a waveguide, and a second surface for frictionally engaging an electrically conductive gasket;
b) positioning said gasket between opposing second surfaces, such that the gasket contacts at least one circumferentially extending, axially projecting ridge formed on each second surfaces;
c) inserting a first end of a first waveguide into said first surface of one of said flanges and inserting a first end of a second waveguide into said first surface of second of said flanges; and
d) applying axial pressure to said first surfaces so as to deform the gasket by the ridges.

2. The method as recited in claim 1 wherein said at least one gasket is circumscribed by a second gasket.

3. The method as recited in claim 2 wherein the second gasket is deformed by a second axially projecting ridge formed from a region of the second surface that is radially displaced from said at least one ridge.

4. The method as recited in claim 2 wherein said at least one gasket and said second gasket comprise different materials.

5. The method as recited in claim 1 wherein said at least one gasket defines a fluid passageway across its surface.

6. The method as recited in claim 5 wherein said passageways extend radially across the gasket.

7. The method as recited in claim 1 wherein said at least one gasket is deformed by the at least one circumferentially extending axially projecting ridge and a second circumferentially extending axially projecting ridge which is position radially from said at least one circumferentially extending axially projecting ridge.

8. A combination of two genderless flanges and a gasket suitable for joining two high vacuum waveguides with a common inner cross-section, said combination comprising a first electrically conductive gasket positioned between a pair of flanges with said gasket having an aperture duplicating the inner cross-section of the waveguides to within 100 microns and with said gasket effecting two concentric seals between said two flanges.

9. The combination as recited in claim 8 wherein said gaskets comprise an oxygen-free metal selected from the group consisting of copper, tin, silver, gold, platinum, iron, aluminum, indium, alloys thereof, and combinations thereof.

10. A system of genderless flanges suitable for joining two high vacuum waveguides with a common inner cross-section, said system comprising a first electrically conductive gasket positioned between opposing surfaces of two identifical flanges with said gasket having an aperture duplicating the inner cross-section of the waveguides to within 100 microns.

11. The system as recited in claim 10 wherein said first gasket comprises an oxygen-free metal selected from the group consisting of copper, tin, silver, gold, platinum, iron, aluminum, indium, alloys thereof, and combinations thereof.

12. The system as recited in claim 10 further comprising a second gasket between the flanges and radially disposed from the electrically conductive gasket.

13. The system as recited in claim 10 further comprising a fluid passageway across said first electrically conductive gasket.

14. The system as recited in claim 10 wherein each of said opposing surfaces define at least one circumferentially extending, axially projecting ridge, and the ridges directly oppose each other.

15. The system as recited in claim 10 wherein each of said opposing surfaces define a first circumferentially extending, axially projecting ridge and a second circumferentially extending, axially projecting ridge coaxial to, and radially, disposed from the first ridge.

16. The system as recited in claim 15 wherein the first gasket is deformed by said first and second ridges.

17. The system as recited in claim 15 wherein the first gasket is deformed by said first ridges and a second gasket is deformed by said second ridges.

18. The system as recited in claim 13 wherein the fluid passageway is formed into at least one of said the opposing surfaces.
